(19) United States
(12) Patent Application Publication
(10) Pub. No.: US 2025/0091611 A1
(43) Pub. Date: Mar. 20, 2025

(54) CONTROL DEVICE, CONTROL METHOD, AND RECORDING MEDIUM

(71) Applicant: NEC Corporation, Minato-ku, Tokyo (JP)

(72) Inventors: Ning LI, Tokyo (JP); Takashi TACHIKAWA, Tokyo (JP)

(73) Assignee: NEC Corporation, Minato-ku, Tokyo (JP)

(21) Appl. No.: 18/728,890

(22) PCT Filed: Jan. 16, 2023
(86) PCT No.: PCT/JP2023/001024

§ 371 Date: Jul. 15, 2024

(30) Foreign Application Priority Data
Mar. 28, 2022 (JP) 2022-051682

(51) Int. Cl. B60W 60/00; H04N 23/667

(52) U.S. Cl. CPC B60W 60/0015; H04N 23/667; B60W 2420/403

(57) ABSTRACT

This control device is provided with: one or more memories storing instructions; and one or more processors configured to execute the instructions to: detect a dangerous area on the basis of sensor information about a management area where a moving body moves; switch a camera for capturing an image of the dangerous area to a low-delay mode; and notify the moving body according to the state of the dangerous area included in the image captured by the camera.

### TECHNICAL FIELD

The present disclosure relates to a control device and the like.

### BACKGROUND ART

PTL 1 describes an imaging device that transmits an image at a frame rate set for each area of the image. In the imaging device described in PTL 1, for example, the higher a risk of an object in the area of the image, the higher the frame rate is set. PTL 1 describes a vehicle control system that detects and avoids a dangerous event based on an image imaged by the imaging device.

### CITATION LIST

### Patent Literature

PTL 1: WO 2019/077999 A1

### SUMMARY OF INVENTION

### Technical Problem

However, the imaging device described in PTL 1 only discloses that an image is transmitted at a high frame rate when the risk is high for the purpose of reducing an amount of image transfer. That is, PTL 1 does not describe avoiding a dangerous event based on a transmitted image. In general, it is necessary to be able to quickly avoid dangerous events. Therefore, there is a need for a technology that prevents a timing of starting a measure against a dangerous event from being delayed.

An object of the present disclosure is to provide a technique capable of advancing timing of control of a moving body for a dangerous event.

### Solution to Problem

A control device according to one aspect of the present disclosure includes: a detection means for detecting a dangerous area based on sensor information about a management area where a moving body moves;

a camera switching means for switching a camera that captures the dangerous area to a low delay mode; and a notification means for notifying the moving body according to a state of the dangerous area included in an image captured by the camera.

A control method according to one aspect of the present disclosure causes a computer to execute: detecting a dangerous area based on sensor information of a management area where a moving body moves; switching a camera that captures the dangerous area to a low delay mode; and notifying the moving body according to a state of the dangerous area included in an image captured by the camera.

A recording medium according to one aspect of the present disclosure records a control program for causing a computer to execute: processing of detecting a dangerous area based on sensor information about a management area where a moving body moves; processing of switching a camera that captures the dangerous area to a low delay mode; and processing of notifying the moving body according to a state of the dangerous area included in an image captured by the camera.

### Advantageous Effects of Invention

An example of an effect of the present disclosure is that a timing of controlling a moving body for a dangerous event can be advanced in a management area where the moving body moves.

### BRIEF DESCRIPTION OF DRAWINGS

FIG. 1 is a block diagram illustrating a configuration of a control device in a first example embodiment.

FIG. 2 is an image diagram of a control system 10 in the first example embodiment.

FIG. 3 is a flowchart illustrating an operation of the control device in the first example embodiment.

FIG. 4 is a block diagram illustrating a configuration of a control system 20 in a first modification.

FIG. 5 is an image diagram of the control system 20 in the first modification.

FIG. 6 is a diagram illustrating a hardware configuration in which the control device according to the present disclosure is achieved by a computer device and peripheral devices of the computer device.

### EXAMPLE EMBODIMENT

Example Embodiments of the present disclosure will be described in detail with reference to the drawings.

In the following description, a moving body is an object that moves in the management area. The moving body is electronically controlled by, for example, a computer. The moving body may be a moving body traveling in a management area such as a robot or a shopping cart. The moving body may be a door which is installed in the management area and whose opening and closing are controlled. All or a part of opening and closing of the door may be controlled. The door is, for example, a door at an entrance of a facility, a door in the facility, or a platform door for preventing falling or the like installed on a platform of a station. The moving body may be one in which all operations are controlled, or one in which some operations such as stopping are controlled. The management area is an area managed using the control device and the control system of the present disclosure in order for the moving body to move safely. That is, the management area is an area where the moving body moves and an area where the camera captures an image. For example, the management area is a facility. The facility is, for example, a store, a warehouse, or a station. The facility is not limited to a building, and may include a facility and surroundings of the facility. The management area may be the outdoors or an area including a facility and the outdoors. The management area may include one or more facilities.

### First Example Embodiment

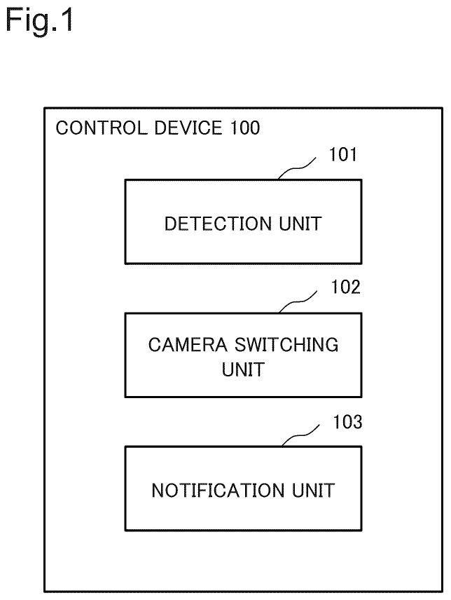

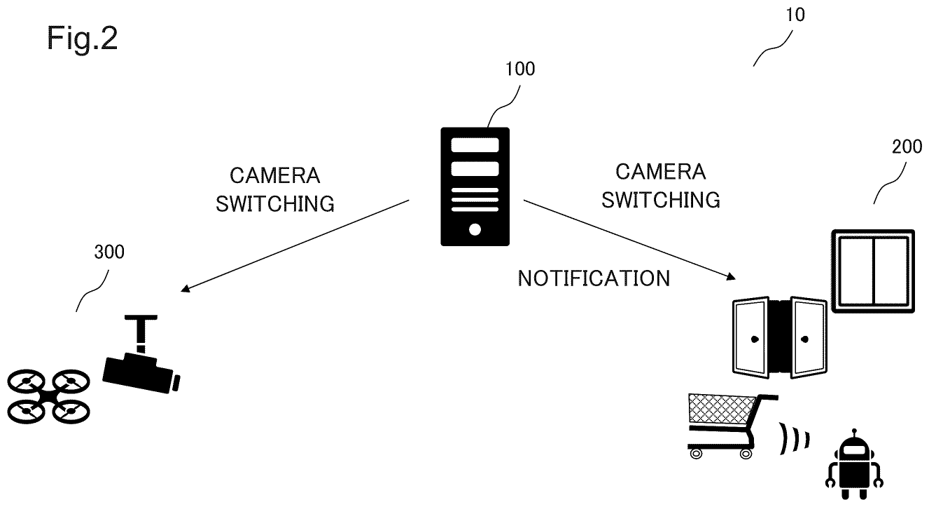

First, an outline of a first example embodiment will be described with reference to FIGS. 1 and 2. FIG. 1 is a block diagram illustrating a configuration of a control device 100 according to a first example embodiment. Referring to FIG. 1, the control device 100 includes a detection unit 101, a camera switching unit 102, and a notification unit 103. The detection unit 101 detects a dangerous area. The camera switching unit 102 switches a mode of the camera that captures the dangerous area to a low delay mode. The notification unit 103 notifies the moving body according to the state of the dangerous area.

FIG. 2 is an image diagram of a control system 10 according to the first example embodiment. Referring to FIG. 2, the control system 10 includes the control device 100, a moving body 200, and a camera 300. The moving body 200 is at least one of a door, a shopping cart, and a robot illustrated in FIG. 2. The number of moving bodies 200 may be one or more. The moving body 200 may be of one type or a plurality of types. The control device 100 switches the camera 300 to the low delay mode via the communication network. The camera 300 is, for example, at least one of a monitoring camera fixedly installed in the management area illustrated in FIG. 2 and a movable monitoring camera mounted on a drone. The control device 100 notifies the moving body 200 via the communication network.

Next, a configuration of the control device 100 according to the first example embodiment will be described in detail.

In FIG. 1, the detection unit 101 is an example of a detection means for detecting a dangerous area based on sensor information of a management area where the moving body 200 moves. The dangerous area is an area where there is a dangerous event. The dangerous event is an event that may cause damage to the moving body 200, equipment in the management area, or a person. The dangerous event may also include a damage that has already occurred. The detection unit 101 may set the dangerous area based on the sensor information.

The dangerous event is, for example, a collision between any of the moving body 200, the equipment, and the person. For example, the dangerous event is to damage what the moving body 200 carries. The dangerous event means that there is an abnormality in the moving body 200, the equipment, the person, or an object. For example, the dangerous event is that there is an abnormality in the operation of the moving body 200, there is an abnormality in equipment, there is a suspicious person, or there is a suspicious object that may interfere with the operation of the moving body or may be a dangerous object. That is, the dangerous area is an area where there is a high possibility that the moving body 200 needs to be controlled. The control of the moving body 200 is, for example, stop, avoidance, or slow traveling. For example, the control of the moving body 200 may be rescue of a person or another moving body that may be damaged or has been damaged by the dangerous event. Alternatively, the control of the moving body 200 may be collection of an object that may cause damage.

The dangerous area is, for example, a crowded place, a child, an elderly person, a suspicious person, a person who is interested in an operation of an electronic device or a product and does not care about the surroundings, a place where a person having a specific attribute that causes a dangerous event is present, a place where an object is dropped, or the like. The dangerous area may be a place where the temperature is high in a factory or the like, a place where the floor or the ground is slippery, or a place where there is a step.

The sensor information for detecting the dangerous area is, for example, an image or audio data. The sensor information is measurement data such as temperature, humidity, slipperiness of a floor or When an image is a ground, or inclination of the floor or the ground. used as the sensor information, an image captured by the camera 300 may be used. For example, the detection unit 101 extracts a specific event as a dangerous event by analyzing image or audio data. The detection unit 101 may detect a range within a predetermined distance from an occurrence place of the dangerous event as the dangerous area. For example, the detection unit 101 may detect a measurement range of measurement data as a dangerous area in a case where the measurement data is out of a range of a predetermined value.

The dangerous area may be set in stages according to a dangerous event. For example, the detection unit 101 may set a degree of danger for each of the plurality of dangerous areas in stages according to a degree of danger of a dangerous event for each of the plurality of dangerous areas. For example, the detection unit 101 may set the degree of danger in one dangerous area in stages according to the distance from the place where the dangerous event occurs. For example, in a case where the closer to the place where the dangerous event occurs, the higher the degree of danger, the detection unit 101 sets the dangerous area in stages according to the distance from the place where the dangerous event occurs. According to the stage of the dangerous area, the camera switching unit 102 to be described later may determine the camera 300 to be switched to the low delay mode. The content of notification by the notification unit 103 to be described later may be changed according to the stage of the dangerous area.

The detection unit 101 may include, as the dangerous area, an area within a predetermined distance from the place where the dangerous event occurs. The predetermined distance may be appropriately set by the detection unit 101 in such a way that the moving body 200 can avoid the dangerous event. For example, the detection unit 101 may set the predetermined distance based on at least one of the current speed, the average speed, and the maximum speed of the moving body. The predetermined distance may be set according to the dangerous event. For example, in a case where the dangerous event is an event caused by a moving body such as a child, the detection unit 101 may set the predetermined distance to be larger than that in a case where the dangerous event is an event caused by a non-moving body such as a dropped object or a step.

Further, detection unit 101 may detect the dangerous area according to an external situation of the management area. For example, when the outside weather is snow or rain, the vicinity of the entrance of the facility included in the management area or a place where many people pass is likely to get wet. In this case, the vicinity of the entrance of the facility or the place where many people pass is an area where the moving body 200 and people are slippery. Therefore, the detection unit 101 may detect the vicinity of the entrance of the facility or the place where many people pass as the dangerous area based on weather information indicating that the outside weather is snow or rain. The detection unit 101 may detect the dangerous area by predicting congestion or an increase in children based on information of an external event. The dangerous area may be detected by time. For example, the dangerous area may be a time and place where congestion is predicted.

The detection unit 101 may predict a dangerous area in which an accident may occur based on the sensor information by using a learned model that has learned a relationship between the sensor information and an accident that has occurred in the past.

The dangerous area is a two-dimensional area or a three-dimensional area. The three-dimensional area is a space. The detection unit 101 may detect the dangerous area according to a movement range of the moving body 200 in such a way that the moving body 200 can avoid the dangerous event. In a case where the moving body 200 is a moving body such as a robot or a cart that moves on the floor or the ground, the detection unit 101 may detect a two-dimensional dangerous area. In a case where the moving body 200 is a moving body such as a drone that moves in a space including a height direction, the detection unit 101 may detect a three-dimensional dangerous area including the height direction. For example, even in a case where the dangerous area is dangerous in two dimensions, when the moving body 200 is a flying moving body, it may be possible to avoid a dangerous event by flying at a certain height. In this case, detection unit 101 may detect a three-dimensional dangerous area including a certain height on the two-dimensional dangerous area.

The camera switching unit 102 is an example of a camera switching means for switching the camera 300 that captures the dangerous area detected by the detection unit 101 to the low delay mode. For example, the detection unit 101 inputs the detected dangerous area to the camera switching unit 102. The camera switching unit 102 switches the camera 300, which includes the acquired dangerous area in a capturing range, to the low delay mode.

The low delay mode is a mode for reducing a delay until processing is performed on an image captured by the camera 300. The low delay mode is, for example, a mode for shortening the time related to encoding and decoding processing after the capturing. The low delay mode may be a mode for shortening the time related to Internet Protcol (IP), transmission, reception, image processing for performing image analysis by artificial intelligence (AI), and the like. In the low delay mode, at least one of the frame rate and the number of pixels of capturing by the camera 300 may be changed. For example, in the present invention, since the camera 300 switched to the low delay mode captures the dangerous area, at least one of the frame rate and the number of pixels may be increased in such a way that the moving body 200 can be appropriately controlled for the dangerous event. The low delay mode is achieved, for example, by increasing the processing capability of an electronic circuit that performs each processing of the camera 300. For example, by increasing the operating frequency (clock frequency) of the electronic circuit, the processing capability of the electronic circuit can be increased. Alternatively, the processing capability of the electronic circuit may be increased by increasing the number of electronic circuits. Here, the electronic circuit is, for example, a central processing unit (CPU), a graphics processing unit (GPU), or a large scale integration (LSI). The LSI is, for example, an LSI dedicated to AI processing. The time not in the low delay mode is the normal mode. The low delay mode uses more hardware resources such as a battery and a memory and network resources than the normal mode. That is, by setting the processing of the camera 300 to the normal mode when it is not dangerous, the camera 300 can efficiently use various resources. The mode switching of the camera 300 may be a change of setting in one camera. Alternatively, the mode of the camera 300 may be switched between a low-delay camera and a non-low-delay camera.

The camera 300 to be switched to the low delay mode by the camera switching unit 102 is a monitoring camera that captures an image of a dangerous area. For example, the monitoring camera is installed in the management area. For example, the monitoring camera may be movable in the management area. The movable monitoring camera is, for example, a monitoring camera installed in the drone. The camera 300 that captures the dangerous area may be a camera included in the moving body 200. The camera switching unit 102 may switch one or more cameras 300 to the low delay mode. A plurality of types of the cameras 300 to be switched to the low delay mode by the camera switching unit 102 may be mixed.

The camera switching unit 102 may determine that the camera is included in the dangerous area based on position information of the camera, an image captured by the camera, communication information, or the like. The fact that the camera 300 is included in the dangerous area means that the camera 300 is present in the dangerous area or that the capturing range of the camera 300 includes the dangerous area. For example, the camera switching unit 102 may determine that the moving body 200 has entered the dangerous area. Also in a case where it is determined that the moving body 200 is approaching or moving toward the dangerous area, the camera switching unit 102 may switch the cameras to the low delay mode.

The camera switching unit 102 may switch the camera 300 capable of capturing an area that is a blind spot from another camera in the dangerous area to the low delay mode. The camera 300 capable of capturing the area that is the blind spot is a camera capable of capturing the area that is the blind spot by moving or changing a direction. In this case, the camera switching unit 102 instructs to switch to the low delay mode and to move or change the direction of the camera 300.

The notification unit 103 is an example of a notification means for notifying the moving body 200 according to the state of the dangerous area included in the image captured by the camera 300 switched to the low delay mode. The notification performed by the notification unit 103 is, for example, an instruction to control the moving body 200, information regarding the dangerous area, and the image obtained by capturing the dangerous area. The notification performed by the notification unit 103 may include sensor information regarding the dangerous area and a voice recorded in the dangerous area.

The notification unit 103 notifies the moving body 200 via the network. Alternatively, in a case where the control system 20 includes a moving body control device that controls the moving body 200, the notification unit 103 may notify the moving body control device. In this case, the moving body control device controls the moving body 200 based on the notification of the notification unit 103. Alternatively, the notification unit 103 may notify the moving body through the moving body control device. In addition to the notification to the moving body 200, the notification unit 103 may notify the moving body 200 or a manager or a management system of the management area of information on the dangerous area.

For example, the notification performed by the notification unit 103 is an instruction to control the moving body 200 according to the state of the dangerous area included in the image captured by the camera 300. The instruction to control the moving body 200 is an instruction to perform control for the moving body 200 to avoid a dangerous event. The state of the dangerous area is, for example, one or more states of a degree of danger of the dangerous area, a state such as movement of a person or an object, a sound, or a temperature that causes a dangerous event, recognition of a range to be avoided, or recognition of a range to slow down. The notification unit 103 may detect the state of the dangerous area from the sensor information used by the detection unit 101.

When the moving body 200 travels in the management area, the instruction to control the moving body 200 is, for example, an instruction to stop the moving body 200 according to the state of the dangerous area. The instruction to control the moving body 200 may be an instruction to move while avoiding a dangerous area or a dangerous event included in the dangerous area, or an instruction to reduce the speed of movement. For example, in a case where there is a dangerous event that a person is running, the moving body 200 stops based on the instruction. For example, in a case where a product or the like carried by the moving body 200 is fragile, the moving body 200 slows down based on the instruction.

In a case where the moving body 200 is a door, the instruction to control the moving body 200 is, for example, an instruction to stop the movement of opening and closing the door. The instruction to control the moving body 200 may be an instruction to close the door.

The notification performed by the notification unit 103 may be at least one of information of the image including the dangerous area, the sensor information regarding the dangerous area, and the voice acquired in the dangerous area. The moving body 200 performs control to avoid the dangerous event based on at least one of the notified image, sensor information, or voice. For example, the notification performed by the notification unit 103 may be information regarding the dangerous area. The information regarding the dangerous area is, for example, position information of the dangerous area. The information regarding the dangerous area may include information indicating a content of the dangerous event occurring in the dangerous area or the degree of danger of the dangerous area. The moving body 200 performs control to avoid the dangerous event based on the notified information regarding the dangerous area.

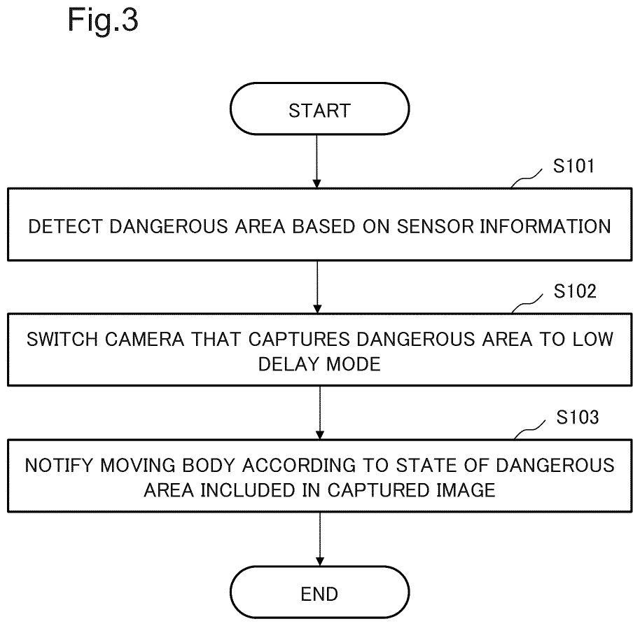

The operation of the control device 100 configured as described above will be described with reference to the flowchart of FIG. 3.

FIG. 3 is a flowchart illustrating an outline of the operation of the control device 100 in the first example embodiment. The processing according to this flowchart may be executed based on program control by a processor.

As illustrated in FIG. 3, first, the detection unit 101 detects the dangerous area based on the sensor information (Step S101).

Next, the camera switching unit 102 switches the camera 300 that captures the dangerous area to the low delay mode (Step S102).

Next, the notification unit 103 notifies the moving body according to the state of the dangerous area included in the captured image (Step S103).

As described above, the control device 100 ends a series of operations.

In the control device according to the present example embodiment described above, the detection unit detects the dangerous area based on the sensor information of the management area where the moving body moves. Then, the camera switching unit switches the camera that captures the dangerous area to the low delay mode. Then, a notification is given to the moving body according to the state of the dangerous area included in the image captured by the camera.

As a result, the control device according to the present example embodiment can advance the timing of control for the dangerous event.

### First Modification

The control device 100 described above may be included in the camera 300.

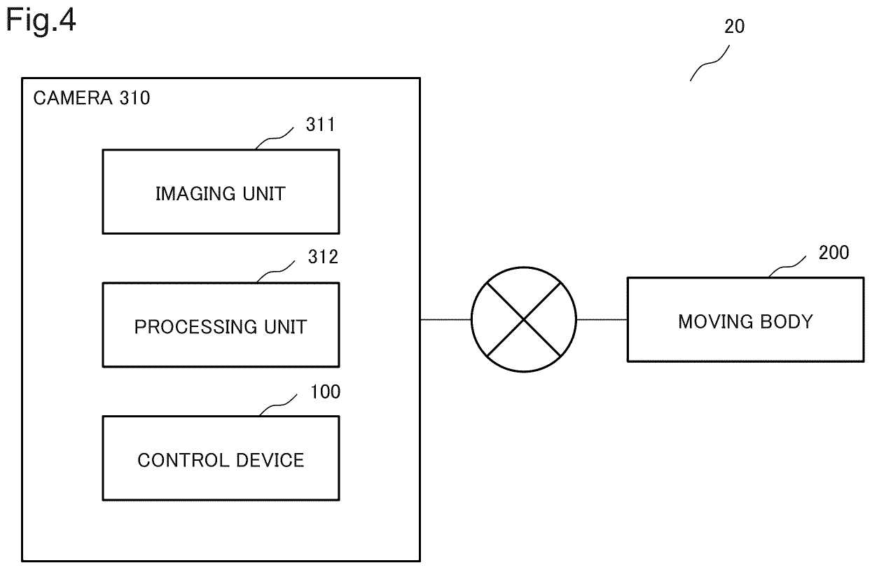

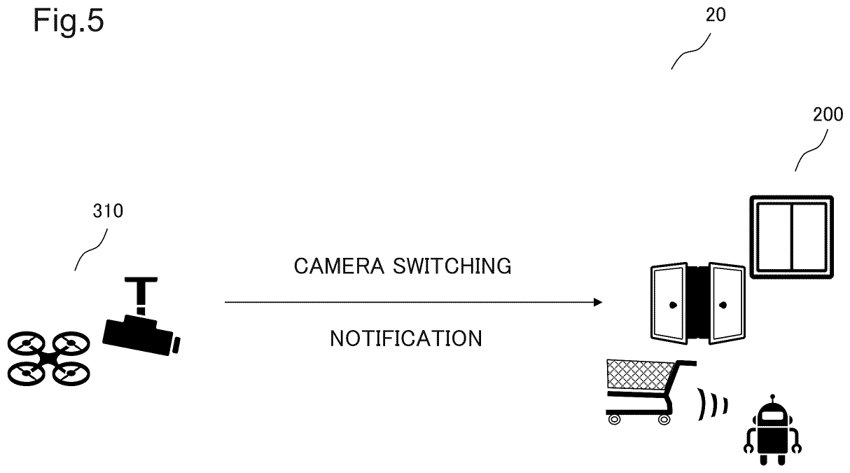

FIGS. 4 and 5 are a block diagram and an image diagram illustrating a configuration of the control system 20 in this case. The control system 20 includes the moving body 200 and a camera 310 including the control device 100.

The camera 310 includes an imaging unit 311, a processing unit 312, and the control device 100. The imaging unit 311 captures an image. The processing unit 312 performs various processes on the captured image. The imaging unit 311 and the processing unit 312 achieves capturing processing of the camera 310. The camera 310 notifies the moving body 200 via the communication network. The camera 310 may switch the camera of the moving body 200 to the low delay mode via the communication network.

The detection unit 101 of the control device 100 included in the camera 310 detects the dangerous area based on the sensor information. The sensor information may be acquired from each sensor or from another device that aggregates the sensor information of each sensor. The camera 310 may include an acquisition unit that acquires the dangerous area detected by another device instead of the detection unit 101.

In a case where the camera 310 captures the dangerous area, the camera switching unit 102 of the control device 100 included in the camera 310 switches the camera 310 to the low delay mode. For example, the camera switching unit 102 switches the processing of the processing unit 312 of the camera 310 to the low delay mode. In a case where the moving body 200 is included in the dangerous area, the camera switching unit 102 may switch the camera included in the moving body 200 to the low delay mode. The camera switching unit 102 may switch another camera 300 that captures the dangerous area to the low delay mode.

As in the first example embodiment described above, the notification unit 103 of the control device 100 included in the camera 310 notifies the moving body 200 according to the state of the dangerous area included in the image captured by the camera. In a case where the control system 20 includes the moving body control device that controls the moving body 200, the notification unit 103 included in the camera 310 may notify the moving body control device. In this case, the moving body control device controls the moving body 200 based on the notification included in the camera 310. Alternatively, the notification unit 103 included in the camera 310 may notify the moving body through the moving body control device.

### Second Modification

When the dangerous area is no longer included in the capturing range, the camera switching unit 102 may switch the camera 300 from the low delay mode to the normal mode. The camera switching unit 102 may switch the camera 300 from the low delay mode to the normal mode in a case where no accident has occurred for a certain period of time, that is, a safe period of time has continued. The camera switching unit 102 may select the timing at which the camera 300 is switched to the normal mode in accordance with a dangerous event in the dangerous area. The timing at which the camera 300 is switched to the normal mode is, for example, when the camera 300 is no longer included in the dangerous area, or when a safe time continues for a certain period of time even if the camera 300 is included in the dangerous area.

The camera 300 may perform other processing in the normal mode. In the normal mode, the camera 300 can use a resource used in the low delay mode for other processing. For example, the camera 300 may perform processing of converting a captured image for transmission or image recognition processing. For example, the camera 310 including the control device 100 may perform machine learning regarding detection of the dangerous area using the accumulated image data in the normal mode. The camera 310 including the control device 100 may update the learned model used for detection of the dangerous area by machine learning regarding detection of the dangerous area using the accumulated image data in the normal mode.

In a case where the camera switching unit 102 switches the camera 300 from the low delay mode to the normal mode, the state of the dangerous area included in the image captured by the camera is in a safe state in the notification unit 103. In this case, the notification unit 103 may notify an instruction to resume the movement of the moving body 200 that has been stopped or return to the normal moving speed.

### Third Modification

In a case where the dangerous area is set in stages according to the degree of danger of the dangerous event, the camera switching unit 102 may change a target camera for camera switching according to the stage of the dangerous area. For example, the camera switching unit 102 may reduce the number of target cameras for camera switching when the degree of danger is small according to the degree of danger of the dangerous event. The camera switching unit 102 may increase the number of target cameras for camera switching when the degree of danger is large. As a result, the camera 300 can efficiently use resources according to the degree of danger.

The content of notification by the notification unit 103 may be changed according to the stage of the dangerous area. For example, the notification unit 103 may preferentially transmit a notification related to a dangerous event having a high danger degree rather than a notification related to a dangerous event having a low danger degree. For example, the notification unit 103 may notify the moving body 200 of control to avoid or stop in a case where the degree of danger of the dangerous event is high. For example, in a case where the degree of danger of the dangerous event is small, the notification unit 103 may notify the moving body 200 of control to slow down.

The notification contents of the notification unit 103 are not limited thereto. The notification unit 103 may perform notification for appropriately controlling the moving body 200 for a dangerous event.

### Fourth Modification

In the present disclosure, the dangerous area may be set in advance. In this case, the detection unit 101 detects that the moving body 200 has entered the dangerous area. Then, the camera switching unit 102 may switch the camera 300 included in the dangerous area into which the moving body 200 has entered to the low delay mode. In other words, the detection unit 101 may detect that the moving body 200 has entered a predetermined area set in advance as a dangerous event. For example, the detection unit 101 detects that the moving body 200 has entered a predetermined area acquired from an internal or external storage unit based on position information of the moving body 200 or an image of the camera 300. Alternatively, the detection unit 101 may detect 200 that the moving body 200 has entered a predetermined area by being notified from the moving body 200 that the moving body 200 itself has entered the predetermined area acquired from an internal or external storage unit. The predetermined area into which the moving body 200 has entered is detected as the dangerous area by the detection unit 101. Then, the camera switching unit 102 switches the camera 300 included in the dangerous area to the low delay mode. The detection unit 101 may detect that the moving body 200 enters the predetermined area after a predetermined time as the dangerous event. The method for detecting the dangerous area by the detection unit 101 in the fourth modification may be combined with each detection method described above.

### Hardware Configuration

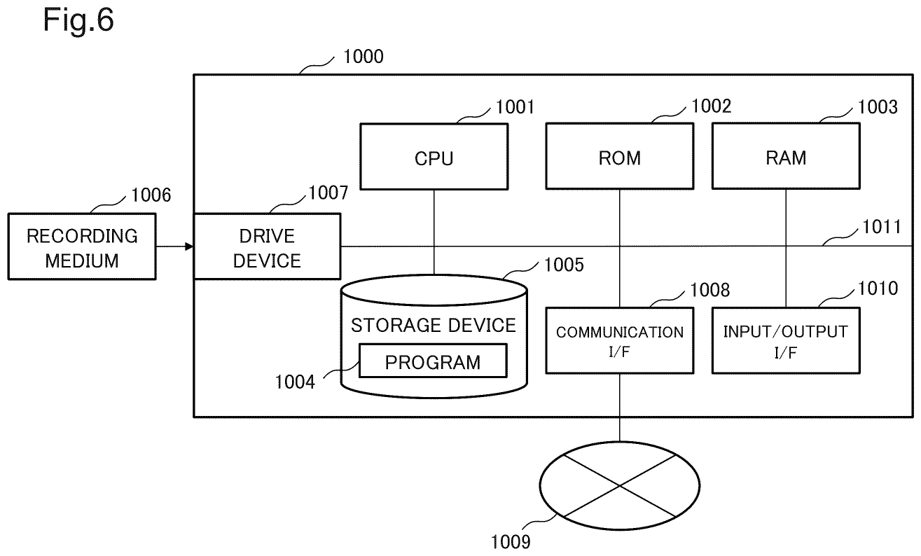

Some or all of components of devices in each example embodiment of the present disclosure described above are achieved by, for example, an arbitrary combination of an information processing apparatus 1000 and a program as illustrated in FIG. 6. The information processing apparatus 1000 includes the following configuration as an example.
Central processing unit (CPU) 1001
Read only memory (ROM) 1002
Random access memory (RAM) 1003
Program 1004 loaded to RAM 13
Storage device 1005 storing program 14
Drive device 1007 for reading and writing recording medium 1006
Communication I/F 1008 connected to communication network 1009
Input/output I/F 1010 for input/output of data
Bus 1011 connecting each component
The I/F is an Abbreviation of Interface.

Each component of each device or system in each example embodiment is achieved by the CPU 1001 acquiring and executing a program for achieving these functions. The program for achieving the function of each component of each device is stored in the storage device 1005 or the RAM 1003 in advance, for example, and is read by the CPU 1001 as necessary. The program 1004 may be supplied to the CPU 1001 via a communication network. Alternatively, the program 1004 may be stored in advance in the recording medium 1006, and the drive device 1007 may read the program and supply the program to the CPU 1001.

There are various modifications of the implementation method of each device. For example, each device or system may be achieved by an arbitrary combination of the information processing apparatus 1000 and the program separate for each component. A plurality of components included in each device may be achieved by an arbitrary combination of one information processing apparatus 1000 and a program.

Some or all of components of each device or system are achieved by general-purpose or dedicated circuitry including a processor or the like, or a combination thereof. The circuit is, for example, a CPU, a graphics processing unit (GPU), a field programmable gate array (FPGA), or a large scale integration (LSI). The LSI is, for example, an LSI dedicated to artificial intelligence (AI) processing. These may be configured by a single chip or may be configured by a plurality of chips connected via a bus. Some or all of components of each device may be achieved by a combination of the above-described circuit or the like and a program.

In a case where some or all of components of each device or system are achieved by a plurality of information processing apparatuses, circuits, and the like, the plurality of information processing apparatuses, circuits, and the like may be arranged in a centralized manner. Alternatively, a plurality of information processing apparatuses, circuits, and the like may be arranged in a distributed manner. For example, the information processing apparatus, the circuit, and the like may be achieved as a form in which each is connected via a communication network, such as a client and server system or a cloud computing system.

While the present invention has been particularly illustrated and described with reference to exemplary embodiments thereof, the present invention is not limited to these example embodiments. It will be understood by those of ordinary skill in the art that various changes in form and details may be made therein without departing from the spirit and scope of the present invention as defined by the claims.

Although the plurality of operations are described in order in the form of a flowchart, the order of description does not limit the order of executing the plurality of operations. Therefore, when each example embodiment is implemented, the order of the plurality of operations may be changed within a range that does not interfere in content.

Some or all of the above example embodiments may be described as the following Supplementary Notes, but are not limited to the following.

### Supplementary Note 1

A control device including:
a detection means for detecting a dangerous area based on sensor information about a management area where a moving body moves;
a camera switching means for switching a camera that captures the dangerous area to a low delay mode; and
a notification means for notifying the moving body according to a state of the dangerous area included in an image captured by the camera.

### Supplementary Note 2

The control device according to Supplementary Note 1, in which
the camera is a monitoring camera that monitors the management area.

### Supplementary Note 3

The control device according to Supplementary Note 1 or 2, in which
the dangerous area is an area where there is a dangerous event.

### Supplementary Note 4

The control device according to any one of Supplementary Notes 1 to 3, in which
the notification is an instruction to control the moving body according to the state of the dangerous area captured by the camera.

### Supplementary Note 5

The control device according to Supplementary Note 4, in which
the notification is an instruction to stop the moving body according to the state of the dangerous area captured by the camera.

### Supplementary Note 6

The control device according to any one of Supplementary Notes 1 to 5, in which
the moving body is a moving body that travels in the management area.

### Supplementary Note 7

The control device according to Supplementary Note 6, in which
when the moving body traveling in the management area enters the dangerous area, the camera switching means switches the camera included in the moving body to the low delay mode.

### Supplementary Note 8

The control device according to Supplementary Note 6 or 7, in which
when the moving body traveling in the management area approaches the dangerous area, the camera switching means switches the camera included in the moving body to the low delay mode.

### Supplementary Note 9

The control device according to any one of Supplementary Notes 6 to 8, in which
the camera switching means switches, to the low delay mode, a camera capable of capturing an area that is a blind spot from a camera provided in the moving body traveling in the management area in the dangerous area.

### Supplementary Note 10

The control device according to any one of Supplementary Notes 1 to 9, in which
the moving body is a door whose opening and closing is controlled.

### Supplementary Note 11

The control device according to Supplementary Note 10, in which
when the door is included in the dangerous area, the camera switching means switches the camera to the low delay mode.

### Supplementary Note 12

A control method for causing a computer to execute:
detecting a dangerous area based on sensor information of a management area where a moving body moves;
switching a camera that captures the dangerous area to a low delay mode; and
notifying the moving body according to a state of the dangerous area included in an image captured by the camera.

### Supplementary Note 13

A recording medium that records a control program for causing a computer to execute:
processing of detecting a dangerous area based on sensor information about a management area where a moving body moves;
processing of switching a camera that captures the dangerous area to a low delay mode; and
processing of notifying the moving body according to a state of the dangerous area included in an image captured by the camera.

This application is based upon and claims the benefit of priority from Japanese patent application No. 2022-051682, filed on Mar. 28, 2022, the disclosure of which is incorporated herein in its entirety by reference.

### REFERENCE SIGNS LIST

10 control system
20 control system
100 control device
101 detection unit
102 camera switching unit
103 notification unit
200 moving body
300 camera
310 camera
1000 information processing apparatus
1001 CPU
1002 ROM
1003 RAM
1004 program
1005 storage device
1006 recording medium
1007 drive device
1008 communication I/F
1009 communication network
1010 input/output I/F
1011 bus

What is claimed is:

1. A control device comprising:
one or more memories storing instructions; and
one or more processors configured to execute the instructions to:
detect a dangerous area based on sensor information about a management area where a moving body moves;
switch a camera that captures the dangerous area to a low delay mode; and
notify the moving body according to a state of the dangerous area included in an image captured by the camera.

2. The control device according to claim 1, wherein
the camera is a monitoring camera that monitors the management area.

3. The control device according to claim 1, wherein
the dangerous area is an area where there is a dangerous event.

4. The control device according to claim 1, wherein
the notification is an instruction to control the moving body according to the state of the dangerous area captured by the camera.

5. The control device according to claim 4, wherein
the notification is an instruction to stop the moving body according to the state of the dangerous area captured by the camera.

6. The control device according to claim 1, wherein
the moving body is a moving body that travels in the management area.

7. The control device according to claim 6, wherein the one or more processors configured to execute the instructions to:
when the moving body traveling in the management area enters the dangerous area, switch the camera included in the moving body to the low delay mode.

8. The control device according to claim 6, wherein the one or more processors configured to execute the instructions to:
when the moving body traveling in the management area approaches the dangerous area, switch the camera included in the moving body to the low delay mode.

9. The control device according to claim 6, wherein the one or more processors configured to execute the instructions to:
switch, to the low delay mode, a camera capable of capturing an area that is a blind spot from a camera provided in the moving body traveling in the management area in the dangerous area.

10. The control device according to claim 1, wherein the moving body is a door whose opening and closing is controlled.

11. The control device according to claim 10, wherein the one or more processors configured to execute the instructions to:
when the door is included in the dangerous area, switch the camera to the low delay mode.

12. A control method for causing a computer to execute:
detecting a dangerous area based on sensor information of a management area where a moving body moves;
switching a camera that captures the dangerous area to a low delay mode; and
notifying the moving body according to a state of the dangerous area included in an image captured by the camera.

13. A non-transitory computer-readable recording medium that records a control program for causing a computer to execute:
processing of detecting a dangerous area based on sensor information of a management area where a moving body moves;
processing of switching a camera that captures the dangerous area to a low delay mode; and
processing of notifying the moving body according to a state of the dangerous area included in an image captured by the camera.
